(19) United States
(12) Patent Application Publication
(10) Pub. No.: US 2019/0303269 A1
(43) Pub. Date: Oct. 3, 2019

(54) METHODS AND SYSTEMS FOR TESTING VISUAL ASPECTS OF A WEB PAGE

(71) Applicant: Layout.io Ltd, Netanya (IL)

(72) Inventor: Guy ARIELI, Even Yehuda (IL)

(21) Appl. No.: 15/937,892

(22) Filed: Mar. 28, 2018

(51) Int. Cl. G06F 11/36; G06F 17/30

(52) U.S. Cl. CPC G06F 11/3664; G06F 17/3089; G06F 11/3696

(57) ABSTRACT

Computerized methods and systems test visual aspects of a web page displayed on a web browser executed on a computing device. Code that includes a plurality of code segments is injected for execution by the web browser. A visually marked element on the web page is selected via an input device connected to the computing device. The web browser executes at least one of the injected code segments to identify the visually marked element as an identified element in response to the selection via the input device, and properties of the identified element are extracted from the web browser.

### TECHNICAL FIELD

The present invention relates to methods and systems for testing web pages.

### BACKGROUND OF THE INVENTION

Website and web application development processes require testing the functionality of the website or application, across combinations of various parameters, including web browser and operating system type and release version. Over the years, software tools have been developed to enable the automatic, or near-automatic, testing of the functionality of the website or web application. However, while such software tools provide capability to properly test functionality, no capabilities are provided to efficiently test the visual appearance of the elements of the website web pages or web application. Other software tools are available to test the visual appearance of the web pages of websites, but these software tools rely on image recognition techniques which are computationally complex and inefficient for testing web pages across large combinations of various parameters.

### SUMMARY OF THE INVENTION

The present invention is directed to computerized methods and systems, which test visual aspects of web pages displayed on web browsers using a graphical user interface integrated with the web browser that operates, for example, as a web browser extension. The web browser is provided with injected JavaScript code for execution which enables the integration of the graphical user interface with the web browser and facilitates operation of the web browser in a web page element identification mode. One or more code segments of the injected JavaScript code are executed by the web browser when a user of the graphical user interface selects elements of the web page that are visually marked in the web page. The selected elements are identified as identified elements and added to an element repository linked to the graphical user interface. The properties of the identified elements are extracted to the graphical user interface from the web browser and are used to generate unique identifiers for uniquely identifying each element. One or more rules are created to test the visual aspects of individual identified elements or to test the visual relationship between multiple identified elements. The rules are executed, either via an external rule execution engine (i.e., accessible over a network) or via a rules module linked to the graphical user interface. A relatively large number of rules can be created and executed in parallel, and the rule outcomes are visually presented in the web page and/or in a results section of the graphical user interface.

Embodiments of the present invention are directed to a method for testing visual aspects of a web page displayed on a web browser executed on a computing device. The method comprises: injecting code that includes a plurality of code segments, for execution by the web browser; selecting a visually marked element on the web page via an input device connected to the computing device; executing, by the web browser, at least one of the injected code segments to identify the visually marked element as an identified element in response to the selecting; and extracting properties of the identified element from the web browser.

Optionally, the method further comprises: generating a unique identifier for the identified element.

Optionally, the generating the unique identifier includes checking at least one attribute of the identified element.

Optionally, the method further comprises: adding the identified element to an element repository.

Optionally, the adding includes capturing a screenshot of the identified element.

Optionally, the method further comprises: selecting, via the input device, the identified element in the element repository; and visually marking an element in the web page on the browser corresponding to the identified element in the element repository.

Optionally, the visually marking the element in the web page includes executing, by the web browser, at least one of the injected code segments.

Optionally, the method further comprises: creating at least one rule based on at least one extracted property of the identified element.

Optionally, the at least one rule includes at least one of: alignment of the identified element, size of the identified element, dimension of the identified element, order of the identified element relative to at least one other element of the web page, and separation of the identified element from at least one other element of the web page.

Optionally, the method further comprises: executing the at least one rule against the web page on the web browser.

Optionally, the web browser is hosted on the computing device.

Optionally, the web browser is hosted on a remote computing device having remote access to the computing device.

Optionally, the method further comprises: grouping the identified element together with at least one other identified element to create a group of elements; and creating a set of rules for the group of elements, the set of rules defining a visual relationship between the elements in the group of elements.

Optionally, the element of the web page includes a document object model (DOM) element.

Optionally, the element of the web page includes a hypertext markup language (HTML) element.

Optionally, the injected code includes at least one JavaScript code segment.

Embodiments of the present invention are directed to a system for testing visual aspects of a web page displayed on a web browser executed on a computing device. The system comprises: a code injection module that injects code, including a plurality of code segments, for execution by the web browser; and a user interface executing an identification module configured to: select a visually marked element on the web page via an input device connected to the computing device, execute, via the web browser, at least one of the injected code segments to identify the visually marked element as an identified element in response to the selecting, and extract properties of the identified element from the web browser.

Optionally, the user interface includes an element repository for storing and listing the identified element.

Optionally, the identification module is further configured to: visually mark an element in the web page on the browser corresponding to the identified element in the element repository in response to selection, via the input device, of the identified element in the element repository.

Optionally, the user interface includes an element identification attributes area for interactively displaying a generated unique identifier for the identified element.

Optionally, the user interface further executes a rules module configured to: create at least one rule based on at least one extracted property of the identified element.

Optionally, the rules module is further configured to execute the at least one rule against the web page on the web browser.

Optionally, the user interface includes a script output that generates a rules script, executable on a rules engine, according to the at least one rule created by the rules module.

Embodiments of the present invention are directed to a method for testing visual aspects of a web page displayed on a web browser executed on a computing device. The method comprises: injecting code that includes a plurality of code segments, for execution by the web browser; selecting an area on the web page via the input device; executing, by the web browser, at least one of the injected code segments to identify an element of the web page located at the selected area; extracting properties of the identified element; and generating a unique identifier for the identified element based on the extracted properties.

Embodiments of the present invention are directed to a system for testing visual aspects of a web page displayed on a web browser executed on a computing device. The system comprises: a code injection module that injects code, including a plurality of code segments, for execution by the web browser; and a user interface executing an identification module configured to: select an area on the web page via the input device, execute, via the web browser, at least one of the injected code segments to identify an element of the web page located at the selected area, extract properties of the identified element, and generate a unique identifier for the identified element based on the extracted properties.

This document references terms that are used consistently or interchangeably herein. These terms, including variations thereof, are as follows:

A “computer” includes machines, computers and computing or computer systems (for example, physically separate locations or devices), servers, gateways, computer and computerized devices, processors, processing systems, computing cores (for example, shared devices), and similar systems, workstations, modules and combinations of the aforementioned. The aforementioned “computer” may be in various types, such as a personal computer (e.g. laptop, desktop, tablet computer), or any type of computing device, including mobile devices that can be readily transported from one location to another location (e.g. smartphone, personal digital assistant (PDA), mobile telephone or cellular telephone).

HTML (Hypertext Markup Language) is the set of markup symbols or codes inserted in a file intended for display on a World Wide Web browser page (i.e., web page) via a web browser.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of the layout of a web browser and components of an exemplary system embodying the invention;

FIG. 2 is a diagram of the architecture of an exemplary system embodying the invention;

FIG. 3 is a diagram illustrating a system environment in which an embodiment of the invention is deployed;

FIG. 4A is a diagram illustrating an example of visually marking an element of a web page, according to an embodiment of the invention;

FIG. 4B is a diagram illustrating an example of identifying an element of a web page and adding the identified to a repository of a graphical user interface, according to an embodiment of the invention;

FIG. 4C is a diagram illustrating an example of visually marking an element in a web page in response to selection of the corresponding element in a repository of a graphical user interface, according to an embodiment of the invention;

FIG. 5 is a flow diagram illustrating a process for testing visual aspects of a web page, according to an embodiment of the invention;

FIG. 6 is a flow diagram illustrating a process for generating a unique identifier for an element of a web page, according to an embodiment of the invention; and

FIG. 7 is a diagram illustrating a system environment in which another embodiment of the invention is deployed.

### DESCRIPTION OF THE PREFERRED EMBODIMENTS

The present invention is directed to computerized methods and systems, which test visual aspects of web pages displayed on web browsers using a graphical user interface integrated with the web browser.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

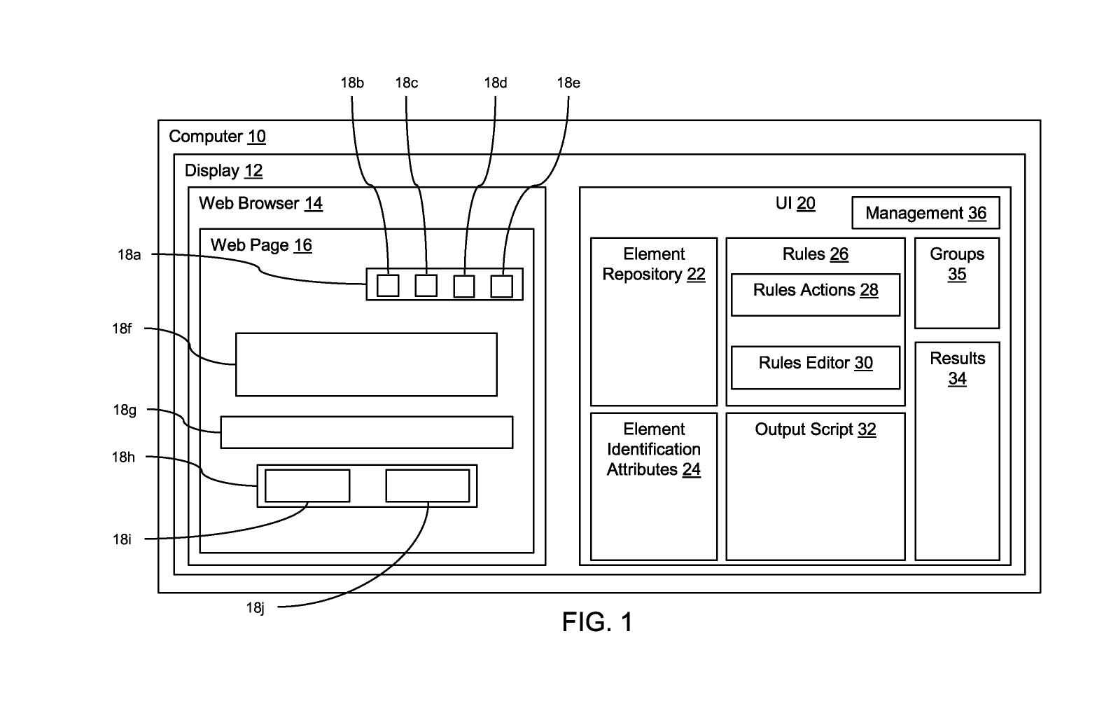

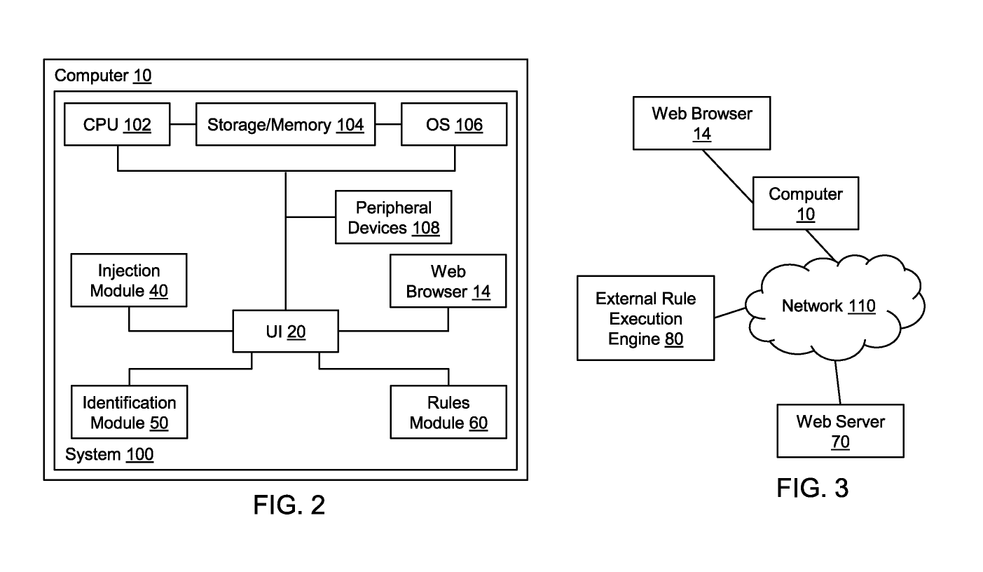

Refer now to FIG. 1, an illustrative diagram of the layout of a web browser 14 and components of a system for testing visual aspects of a web page according to an embodiment of the present disclosure. The system, generally designated 100 in FIG. 2, includes a user interface (UI) 20, that is displayed, together with the web browser 14, on a display 12 of a computer 10. The web browser 14 displays web pages, exemplified by the web page 16, which disseminate information from websites or web applications on the world wide web which access a web server 70 through a network 110 (FIG. 3). The web page 16 includes a plurality of elements 18a-j, exemplified by document object model (DOM) elements of an HTML page attached to the web page 16. The elements of the web page 16 may include various types of elements, which in FIG. 1 are exemplified by header elements 18a-e that are positioned in the header region of the web page 16, graphical element 18f that displays some sort of graphical content (e.g., picture, image, illustration, etc.), text input element 18g that provides functionality for inputting text through a peripheral device of the computer 10, and pushbutton elements 18h-j that provide functionality for activating the web browser 14 to process the content of the web page (e.g., change web page in response to pushbutton activation).

The UI 20 is a graphical user interface that provides the user of the computer 10 with interactive control of the system 100 through graphical icons, push-buttons, visual indicators, and the like. The UI 20 operates as an integrated development environment (IDE) that is integrated into the web browser 14 and operates as a web browser extension. The UI 20 includes several interactive sections (i.e., regions or areas) which include sections for displaying different features of the web page 16 and sections for controlling and commanding the system 100 to performed actions. As illustrated in FIG. 1, the UI 20 includes an element repository 22 for providing an interactive list of elements identified in the web page 16, element identification attributes 24 providing an interactive list of the attributes or properties of an element which are used to uniquely identify the element, rules 26 separated into rules actions 28 (e.g., executing rules) and rules editor 30 (e.g., creating rules) areas, an output script 32 area for displaying an output test script for execution by an external rules engine, a results 34 area for displaying visual results of executed rules, a groups 35 area for creating groups of identified elements and managing the created groups, and management 36 for performing user management actions such enabling and disabling web browser modes.

It is noted herein that the layout of the UI 20 as illustrated in FIG. 1 is a non-limiting example representation of one of many different possible layouts of the UI 20. As should be understood by one of ordinary skill in the art, modifications to the individual items of the UI 20, and the layout arrangement thereof, are possible, and in certain embodiments, may be adjusted or modified by a user of the computer 10 according to user preferences.

FIG. 2 shows the computer 10 and the system 100 therein, as an architecture, with the UI 20 incorporated into the system 100 of the computer 10. In addition to the UI 20, the system 100 includes an injection module 40 for injecting JavaScript code into the web browser 14 to change the behavior of the web browser 14 to enable the UI 20 and the web browser 14 to identify corresponding elements in the web page 16. The system 100 further includes an identification module 50 for identifying elements in the web page 16 in accordance with the injected code, and a rules module 60 for creating and executing rules for testing the visual aspects of the web page 16. All components of the computer 10 and/or the system 100 are connected or linked to each other (electronically and/or data), either directly or indirectly.

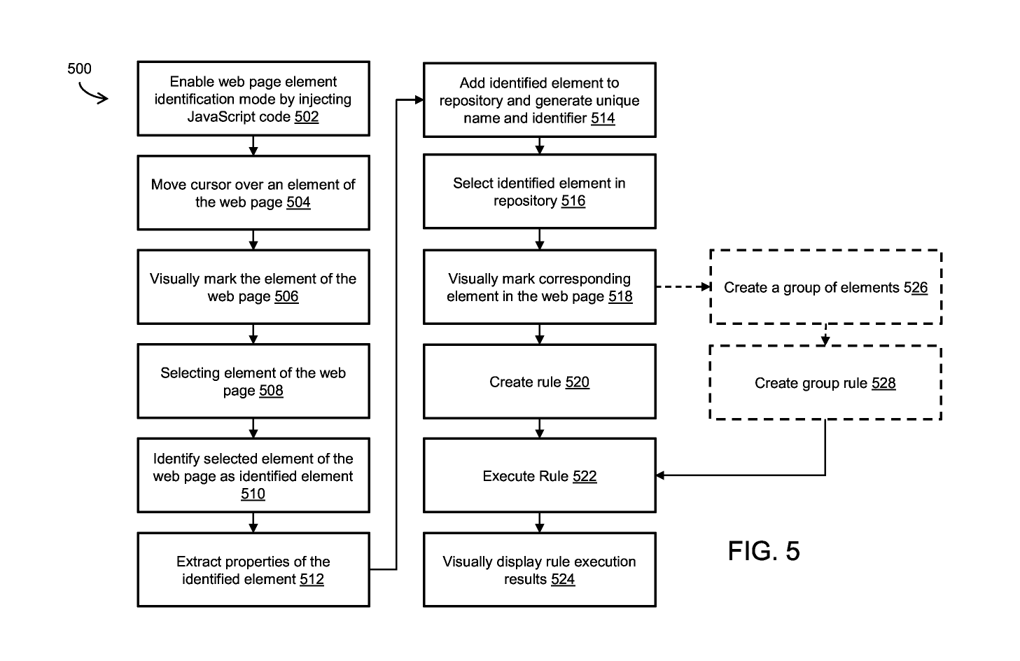

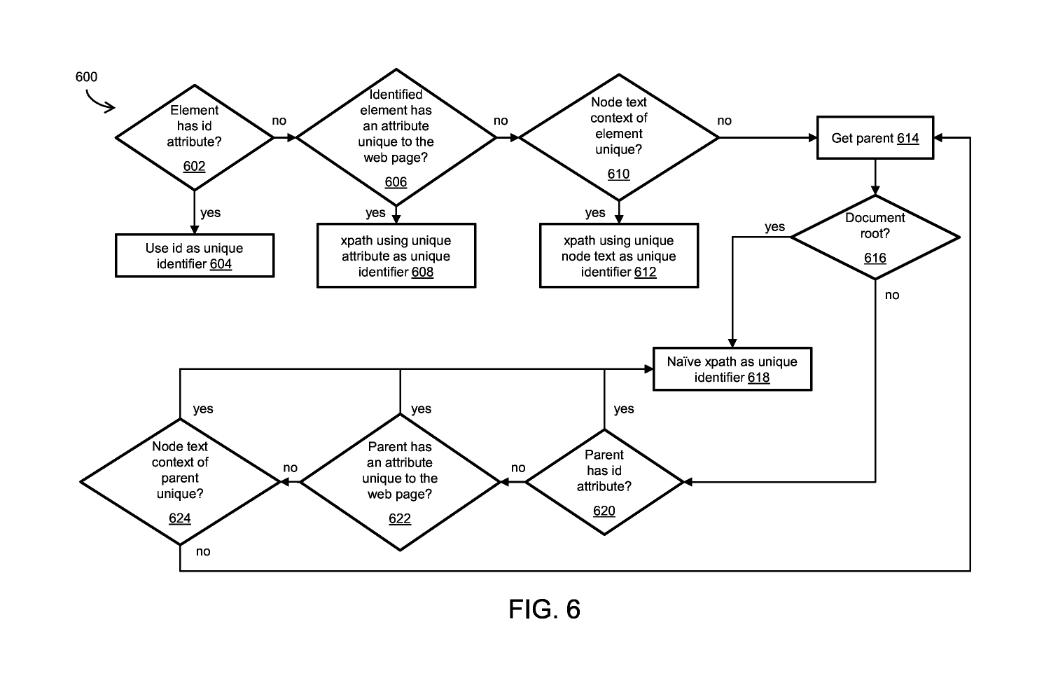

In addition to the UI 20 and the modules 40, 50, 60 mentioned above, the computer 10 further includes a CPU 102, a storage/memory 104, an operating system (OS) 106, peripheral devices 108, and the web browser 14. The processors of the CPU 102 and the storage/memory 124, although shown as a single component fur representative purposes, may be multiple components. The CPU 102 is formed of one or more processors, including microprocessors, for performing the computer 10 functions, including executing the functionalities and operations of the web browser 14 and the modules 40, 50, 60, as detailed herein, the OS 106, and including the processes shown and described in the flow diagrams of FIGS. 5 and 6. The processors are, for example, conventional processors, such as those used in servers, computers, and other computerized devices. For example, the processors may include x86 Processors from AMD and Intel, Xeon® and Pentium® processors from Intel, as well as any combinations thereof.

The storage/memory 104 is any conventional storage media. The storage/memory 104 stores machine executable instructions for execution by the CPU 102, to perform the processes of the present embodiments. The storage/memory 104 also includes machine executable instructions associated with the operation of the components, including the web browser 14 and the modules 40, 50, 60, and all instructions for executing the processes of FIGS, 5 and 6, detailed herein.

The OS 106 includes any of the conventional computer operating systems, such as those available from Microsoft of Redmond Wash., commercially available as Windows® OS, such as Windows® XP, Windows® 7, MAC OS and iOS from Apple of Cupertino, Calif., or Linux based operating systems such as those available from Google of Menlo Park Calif., commercially available as Android OS.

The peripheral devices 108 are devices which are connectable to the computer 10 to allow a computer user to interact with the computer 10 so as to provide input to the computer 10, and in particular the applications executed by the OS 106, including the UI 20 and the web browser 14. The peripheral devices 108 include, for example, a computer mouse and a keyboard, connectable to the computer 10 through appropriate interfaces (e.g., USB, etc.). Such devices are considered input devices which provide the computer user with a means for providing input to the computer 10.

The web browser 14 is, for example, any web browser used on a computer system for accessing data on the world wide web, such as, for example, Microsoft® Internet Explorer®, Mozilla Firefox®, or Google Chrome®. The web browser 14 executes web server code received from the web server 70 (FIG. 3), as well as code injected by the injection module 40.

The code injection module 40, the identification module 50, and the rules module 60 may be implemented as hardware, firmware and/or software. In the exemplary system 100 of the embodiments of the present disclosure, the modules 40, 50, 60 are, for example, implemented as software, and implemented as executable code that is stored in a non-volatile memory, such as, for example, the storage/memory 104 of the computer 10, and executed by a processor, such as, for example, the CPU 102 of the computer 10. It is noted that each of the modules 40, 50, 60 may include a dedicated non-volatile memory for storing executable code, and a dedicated processor for executing the code stored in the dedicated non-volatile memory.

FIG. 3 illustrates an example environment in which embodiments of the present disclosure may be performed over a network, namely the network 110. The network 110 may be formed of one or more networks, including for example, the Internet, cellular networks, wide area, public, and local networks. The computer 10 is connected to the network 110, thereby connecting the UI 20 and the web browser 14 to the network 110. In addition, the web server 70 is connected to the network 110 allowing access to websites or web applications which display information, in the form of the web page 16, on the web browser 14. The web browser 14 displays web pages, exemplified by the web page 16, which disseminate information from websites or web applications on the world wide web which access the web server 70. An external rule execution engine 80 is also connected to the network 110, which allows execution of rules created by the rules editor 30. The external rule execution engine 80 may be implemented as any open source commonly known rule execution agent, such as, for example, the Galen Framework open source testing environment, accessible through the URL galenframework.com.

In an exemplary series of processes to test visual aspects of the web page 16, a user (i.e., web page tester) operates the system 100 to enable a web page element identification mode, referred to hereinafter as element identification mode. Enabling of element identification mode is performed by clicking (via a mouse connected to the computer 10) on a button in the UI 20, for example, in the management 36 section of the UI 20. In response, the injection module 40 injects JavaScript code that includes multiple code segments into the web browser 14, which upon execution by the web browser 14, alters the behavior of the web page 16 displayed in the web browser 14.

In element identification mode, a virtual layer is deployed on top of the web page 16, preventing mouse-click events from initiating normal web page behavior. Normal web page behavior generally refers to the behavior of a web page when browsed by a user on a standard computer or mobile device. For example, when a web page operates within the context of normal behavior, performing a mouse click event on a link in the web page will navigate to another web page addressed by the link (either of the same website or another website). For example, normal web page behavior of the URL google.com includes execution of the search in the search box and navigating to the web page that displays the search results in response to a mouse-click event detected on the button “Google Search”. Accordingly, when operating in element identification mode, performing a mouse-click event will not navigate to the web page addressed by the link. Instead, other actions are performed by the UI 20 and the web browser 14 in response to detected mouse-click events, as will be described in further detail in subsequent sections of the present disclosure.

The virtual layer may be implemented as a result of one of the segments of code injected by the injection module 40, which may include modifications to mouse event related JavaScript functions.

Once the system 100 is in element identification mode, the user is able to utilize the system 100 to identify elements of the web page 16, and subsequently create and execute rules based on the properties of the identified elements.

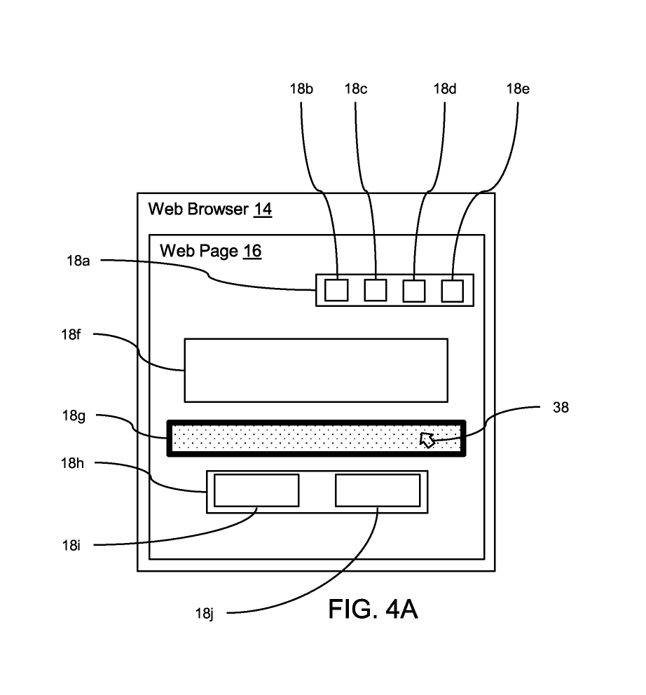

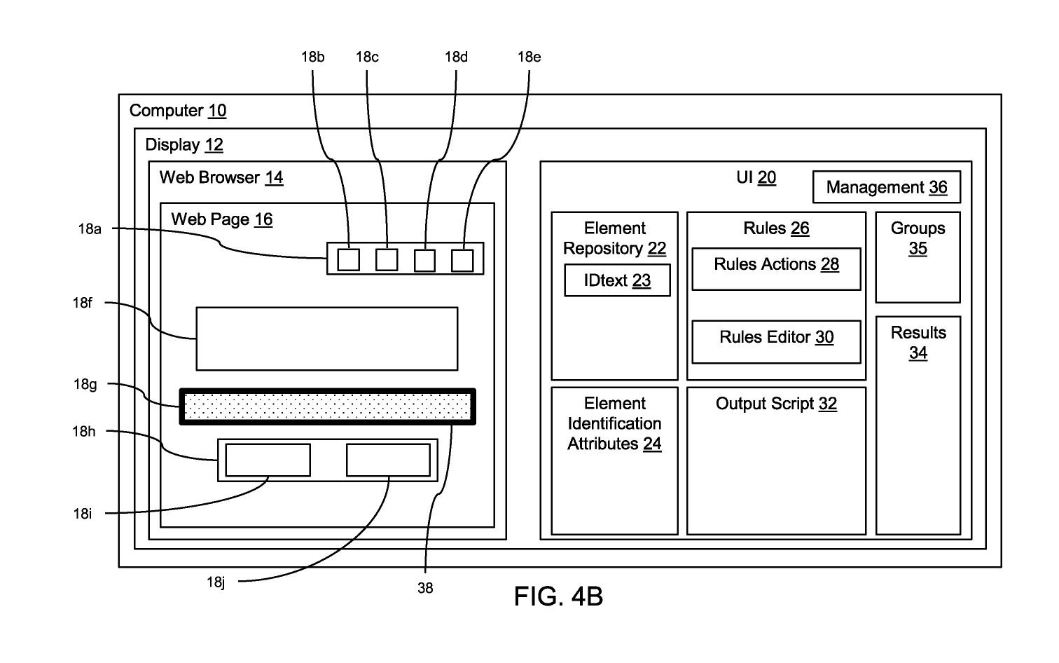

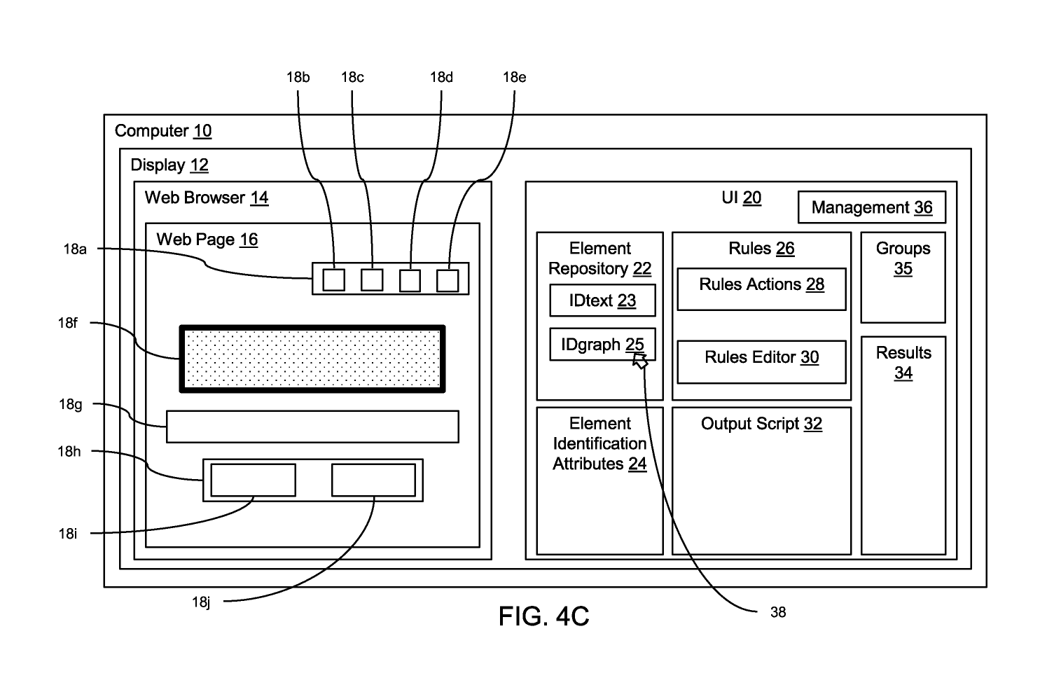

To identify elements, the elements may first be visually identified by the system 100. Visual identification of elements in the web browser 16 is performed by moving the mouse such that the mouse cursor is positioned over one of the elements 18a-j. When the mouse cursor is moved into position over one of the elements 18a-j, an event is triggered a result of the injected JavaScript code execution) to visually mark the element to highlight or otherwise visually distinguish the element from the remaining elements, thereby allowing the user to visually identify the element in the web browser 14. FIG. 4A illustrates an example of the web page 16 displayed in the web browser 14 in which the mouse cursor 38 is moved into position over the text input element 18g such that the text input element 18g is highlighted (exemplified by bold lines with patterned fill).

The visually marked element may then be selected by the user via a mouse-click performed anywhere within the highlighted area corresponding to the visually marked element. In response to the mouse-click, the web browser 14 executes one or more of the injected JavaScript code segments to identify the element (i.e., DOM element) that exists at the location of the web page 16 at which the mouse cursor 38 is positioned during the mouse-click. In the example illustrated in FIG. 4A, performing a mouse-click with the mouse cursor 38 positioned in the highlighted area corresponding to the text input element 18g identifies the text input element 18g as the element that exists at the location of the web page 16 at which the mouse cursor 38 is positioned during the mouse-click.

Subsequently or in parallel to the identification of the element, the system 100 extracts the properties of the identified element from the web browser 14 to the UI 20. In general, all of the properties of the identified element are extracted from the browser 14. The extracted properties include, but are not limited to, web DOM node attributes, such as, for example, id, name, and class, as well as general layout properties, such as, for example, element size and element position (i.e., location) in the web page 16. Note that the web DOM attributes are used by the system 100 to assign a unique name and identifier to the identified element in order to uniquely identify the identified element, as will be described in more detail in subsequent sections of the present disclosure.

Subsequently or in parallel to the property extraction, the system 100 adds the element to the element repository 22 where the element is displayed in an interactive list of identified elements, according to a unique name and a unique identifier generated by the system 100. A screenshot of the identified element is also captured, and stored, for example as an image file, in a memory of the computer 10, for example the storage/memory 104. FIG. 4B illustrates an example in which the text input element 18g is selected by a mouse-click, causing the system 100 to extract the properties of the text input element 18g and add the text input element 18g to the element repository 22, designated as 23, under the unique name IDtext having a corresponding unique identifier.

The system 100 generates the unique name and the unique identifier for the identified element and assigns the unique identifier to that unique element name. The unique name is generated based on the element identification attributes in the extracted element properties. The generation of the unique identifier is performed algorithmically, based on the element identification attributes in the extracted element properties. The following paragraphs describe the general steps of the algorithmic process for generating the unique identifier.

Initially, the system 100 analyzes the extracted element properties to check if the element has an id attribute. If such an id attribute exists, the id attribute is used to uniquely identify the element. If such an id attribute does not exist, the system 100 analyzes the extracted element properties to check all attributes of the element in order to determine if one of the attributes is unique in the web page 16. If such a unique attribute is found, the xpath of that attribute is used to uniquely identify the element. For example, if a unique attribute of ‘name’ is found with a field value of ‘btnK’, the xpath //*[@name=‘btnK’] is used to uniquely identify the element. If no such unique attribute is found, the system 100 analyzes the extracted element properties to determine whether the node text context of the element is unique in the web page 16. If the node text context is unique, the xpath of that node text is used to uniquely identify the element. For example, if the node text ‘OK’ of the element is unique, the xpath //*[text( )=‘OK’] is used to uniquely identify the element. If the node text context is not unique, the system 100 recursively checks the above id, unique attribute and unique node text criteria for the parent elements of the identified element until such criteria are satisfied or the document root is reached to set the unique identifier of the identified element.

As illustrated above, if the system 100 cannot uniquely identify the element using the three identification criteria (i.e., id attribute, unique attribute, or unique node text) the parent element of the element to be identified is selected and the same three identification criteria are applied recursively until the root of the document is reached. Once the parent (or document root) is uniquely identifiable by the system 100, the system 100 uses a naïve xpath to uniquely identify the element. The naïve xpath uses the node name and the index of the parent (or document root) to uniquely identify the element based on whichever of the three identification criteria is satisfied. For example, consider the case in which neither the element that is to be uniquely identified by the system 100, nor the first three parents of the element, can be identified by the three identification criteria mentioned above (i.e., id attribute, unique attribute, or unique node text), but the fourth parent of the element to be identified has a unique id attribute, for example ‘menu-item-8537’. In such an example, the naïve xpath id(“menu-item-8537”)/DIV[1]/DIV[1]/DIV[1]/H1[1] is used to uniquely identify the element, where H1[1] is the element that is to be uniquely identified, DIV[1] are the first three parent elements with no unique identification, and id(“menu-item-8537”) is the unique id attribute of the fourth parent element.

The unique identifier generated by the system 100 creates a one-to-one mapping between an element in the web page 16 of the web browser 14 and a corresponding element in the element repository 22. The attributes used to uniquely identify the identified element are displayed in the element identification attributes 24 section of the UI 20. The user of the system 100 may modify the attributes in the extracted element properties used to uniquely identify an element.

The above described steps in the exemplary series of processes function to test the identification of elements in web page 16 by the UI 20 and to add identified elements along with element properties and attributes to the UI 20. The following steps describe additional testing functionality which allows the user to become visually familiar with the elements already added to the UI 20. By employing this functionality, elements already added to the UI 20 are visually identified (i.e., marked) in the web page 16. The testing is performed by selecting, via a mouse-click, an element in the element repository 22 in the UI 20. In response to selecting one of the elements in the element repository' 22, one of the injected JavaScript code segments is executed by the web browser 14 to visually mark the element in the web page 16 of the web browser 14 that corresponds to the unique identifier of the element selected in the element repository 22. As such, the visually marking allows the user to visually distinguish the selected element in the web browser 14 from the remaining elements in the web browser 14. The visual marking may be implemented by highlighting the selected element or performing any other visually distinguishing action in order to visually distinguish the selected element from the remaining elements, thereby allowing the user to visually identify the element in the web browser 14.

The steps for visually marking elements in web page 16 in response to selection of elements in the element repository 22 are further explained by example with reference to FIG. 4C. As illustrated in FIG. 4C, two elements are shown in the element repository 22: the text input element 18g from the previous example under the unique name IDtext 23, and the graphical element 18f under the unique name IDgraph 25 (having a corresponding unique identifier). In response to a mouse-click on IDgraph 25 in the element repository 22, exemplified by the mouse cursor 38 positioned on the IDgraph 25, one of the injected JavaScript code segments is executed by the web browser 14 to visually mark (exemplified by bold lines with patterned fill) the corresponding graphical element 18f on the web page 16 of the web browser 14.

Once the user verifies that elements are properly identified by the UI 20, via the execution of the above described steps in the exemplary series of processes, the user may operate the system 100 to group together identified elements, before operating the system 100 to perform rules related tasks. In general, the user may select, via mouse-click, multiple identified elements and group such elements together to create an element group. For example, the user may select a subset of the elements listed in the element repository 22 to create a group consisting of the subset of selected elements. Groups of elements, along with properties of the group, are provided in the groups 35 section of the UI 20. Note that in certain embodiments, groups of elements may alternatively be displayed in the element repository 22 and not in a separate groups 35 section of the UI 20. Typically, the elements within a group of elements have similar or common properties and attributes which make such elements conducive to being placed together in a group. For example, the header elements 18a-e, once identified and added to the element repository 22, may be grouped together to form a group. The user can set the name of a group and can later change the name of the group. In addition, the user can operate the system 100 to modify the group by removing elements from the group, adding elements to the group, and deleting the entire group. All group modification and naming modification is performed via, for example, mouse-click and keyboard commands in the groups 35 section of the UI 20.

In addition to the above-mentioned group modification and name modification, the user can operate the system 100 to verify all elements in a group on the web page 16 of the web browser 14. For example, if a group titled HEADER. ELEMENTS is created that includes the header elements 18a-e, clicking on the HEADER ELEMENTS group in combination with a verify command (for example in the management 36 section) causes the web browser 14 to execute one of the injected JavaScript code segments to visually mark (e.g., highlight) the corresponding header elements 18a-e on the web page 16 of the web browser 14.

Once the user verifies that elements, either individual or in groups, are properly identified by the UI 20, via the execution of the above described steps in the exemplary series of processes, the system 100 may then be operated to perform rules related activities. The rules related activities may be applied to individual elements, multiple elements, or groups.

The user operates the system 100 to create one or more rules for testing the visual layout of the elements of the web page 16. According to certain embodiments, the rules are created based on the properties of a single element (i.e., for testing an individual element), while still in other embodiment the rules are created to define visual relationships between multiple elements of the web page 16. Each rule may include a set of default values which are set according to the extracted properties of the corresponding element. Creation and modification of rules is performed by the rules module 60 in response to mouse-click and computer keyboard commands in the rules editor 30 of the rules 26 section of the UI 20. Rule creation can be performed by first selecting a single element from the element repository 22 of the UI 20, selecting multiple elements from the element repository 22 of the U120, or by selecting a group from the groups 35 section of the UI 20, and then subsequently performing actions in the rules editor 30 of the rules 26 section of the UI 20.

Examples of an element property used to create a rule based on properties of a single element include, for example, element height, element width, and element font (i.e., for text-based elements). Examples of rules defining visual relationships between elements include, but are not limited to: 1) alignment (e.g., vertical, horizontal, left, right, top, bottom, center) of elements (e.g., all elements to which the rule is applied align to the top of the web page 16), 2) the size of elements (e.g., all elements to which the rule is applied satisfy a required element size have the same height and/or width), 3) the relative position elements (e.g., one element inside of another element), 4) the order of elements (e.g., all elements to which the rule is applied are arranged in a specific order, such as, from left to right, in the web page 16), and 5) the non-overlapping (i.e., separation) of elements (e.g., none of the elements to which the rule is applied overlap with each other). For example, for a specific set of three identified elements, the user can operate the system 100 to create a first rule that requires that the elements are aligned with each other relative to a vertical axis, and a second rule that requires that one of the three elements is vertically centered between the other two elements. Considering the positional relationship between the graphical element 18f, the text input element 18g, and the pushbutton element 18h as illustrated in FIG. 1, these three dements would satisfy the two above-mentioned rules.

More complex rules can be generated, for example, to test the dynamic behavior of the web page 16, for example adjustment of the window size of the web browser 14. For example, consider an array of elements which are arranged in M rows with J elements per row. In certain web pages, as the width of the web browser 14 is decreased, the number of the elements per row or the position of the elements may change. For example, a decrease in width may result in N rows with I elements per row (N>M and I<J), while an increase in width may result in L rows with K elements per row (L<M and K>J). The system 100 may be used to create a rule that requires that the number of elements per row is constant.

As should be apparent, some of the rules require inputting numerical values, such as, for example, values specifying element size, height, or width. Such numerical values have units, having type that includes, but is not limited to, pixels, percentage of the size of the display 12, inches, and centimeters. For example, a height rule may be created by specifying that an element has a height between 16 and 64 pixels, whereas a relative positioning rule may be created by specifying that the horizontal distance between adjacent elements is at least 8 pixels or a fixed value of, for example, 12 pixels.

As mentioned above, each rule may include a set of default values which are set according to the extracted properties of the corresponding element. Based on the element properties extracted by the system 100, the system 100 may suggest different rules and rule properties for individual elements, collections of elements, or groups of elements. For example, the system 100 may suggest (and create) a size rule for a specific element used to validate that the element width and height are as expected. When creating such a rule, the system 100 may then use the original width and height of the element as default rule values of the rule.

Once a rule is defined, the rule may then be executed by the system 100 (i.e., in response to a user command) against the live web page 16 of the web browser 14. In certain embodiments, execution of a rule may be performed by the rules module 60 in response to mouse-click and/or computer keyboard commands in the rules actions 28 of the rules 26 section of the UI 20. In other embodiments, execution of a rule may be performed by the external rule execution engine 80.

According to certain embodiments, a visual result is created and displayed after the rule is executed. Every rule type can have a different visual representation of the visual result. For example, the visual results for certain rule types may be displayed in a separate report in the live web page 16 of the web browser 14, for example, by visually marking elements which do not satisfy the rule according to a first marking type (e.g., red highlighting) and visually marking elements which satisfy the rule according to a second marking type (e.g., green highlighting). Alternatively, or in addition to displaying the visual results in a separate report, the visual results for other types of rules may be displayed in the results 34 area of the UI 20. The visual result may also include a screenshot of the web page 16.

The system 100 facilitates the creation and execution of multiple rules, with each rule testing one or more elements, in parallel, allowing the user (i.e., operator of the system, tester of the web page) to efficiently perform visually testing of the web page 16. According to certain embodiments, the rules can be loaded via a script and executed in parallel, providing a near-automation capability of the web page testing system. As mentioned above, in order to perform the processes for testing visual aspects of the web page 16, the user first enables element identification mode by, for example, performing a mouse-click operation on a button in the management 36 section of the UI 20. Upon completion of the testing processes, the user may perform an additional mouse-click operation on a button in the management 36 section of the UI 20 to disable element identification mode, thereby removing the virtual layer from the web page 16 and reverting the behavior of the web browser 14 and the web page 16 back to normal behavior.

Generally speaking, the system 100 provides functionality for three different types of rule execution. In a first type of rule execution, a single rule or multiple rules are executed against an active (i.e., live) web page (i.e., the web page 16). The first type of rule execution is typically performed by the user of the system 100 in order to validate proper functioning of the rules in the rules creation process.

In a second type of rule execution, the rule or rules are executed against an active web page running on external web browsers that are separate and different from the web browser 14. The second type of rule execution is typically performed in order to test the compatibility between different web browsers (e.g., Microsoft® Internet Explorer®, Mozilla Firefox®, Google Chrome®, etc.) and the web page under test after undergoing a change to, for example, the properties of the web page (e.g., CSS), implemented by, for example, the web developer.

In a third type of rule execution, unattended (i.e., automated or near-automated) testing is performed, for example via loaded rules scripts, which combine the web page functionality testing, for example as described in the background section of the present document, with the web page visual aspect testing as described in the embodiments of the present disclosure.

Attention is now directed to FIG. 5 which shows a flow diagram detailing a computer-implemented process 500 in accordance with embodiments of the disclosed subject matter. This computer-implemented process includes an algorithm for testing visual aspects of a web page. Reference is also made to the elements shown in FIGS. 1-4C. The process and sub-processes of FIG. 5 are computerized processes performed by the system 100 including, for example, the CPU 102 and associated components, such as the UI 20, the injection module 40, the identification module 50, the rules module 60, and the web browser 14. The aforementioned processes and sub-processes are for example, performed automatically, but can be, for example, performed manually, and are performed, for example, in real-time. Prior to execution of the steps of the process, the user of the computer 10 first launches the UI 20 (i.e., the IDE that is the extension of the web browser 14) via, for example a mouse-click or command line script.

It is noted that the process 500 is a non-limiting example of a process for testing visual aspects of a web page according to embodiments of the present disclosure. The process 500 includes steps relating to rule creation and rule execution, for both single or multiple elements and for groups of the elements. The description of the rule creation and execution steps in the process 500 generally relate to the first type of rule execution discussed above. As should be apparent to one of ordinary skill in the art, variations or modifications to the steps of the process 500 can be applied in order to perform rule execution in the spirit of the second and/or third types of rule execution discussed above.

The process 500 begins at block 502, where the user of the computer 10 enables element identification mode, via, for example, a mouse-click initiated push-button command in the management 36 section of the UI 20. In response to enabling element identification mode, JavaScript code, that includes multiple code segments, is injected by the injection module 40 into the web browser 14 to alter the behavior of the web page 16 and the web browser 14.

The process 500 then moves to block 504, where the user positions the cursor 38 associated with the computer mouse over an element of the web page 16. The cursor 38 is moved into position over the element by physical movement of the mouse by the user. The process 500 then moves to block 506, wherein when the cursor 38 is moved into position over the element, an event is triggered (as a result of the injected JavaScript code execution) to visually mark (e.g., highlight) the element in the web browser 14. The process 500 then moves to block 508, where the user selects an element of the web page 16 (which is the visually marked element), by clicking, via the mouse, on an element in the web page 16. The process 500 then moves to block 510, where in response to the mouse-click, one of the injected JavaScript code segments is executed by the web browser 14 to identify the element that exists at the location of the cursor 38 during the mouse-click.

The process 500 then moves to block 512, where the properties of the element identified in block 510 are extracted from the web browser 14 to the III 20 and stored and displayed in the element identification attributes 24 of the UI 20. The process 500 then moves to block 514, where a unique identifier of the element identified in block 510 is generated and assigned to the identified element, and the identified element is added to the element repository 22 according to the generated unique identifier. The process for generating the unique identifier in block 514 will be described in more detail in subsequent sections of the present disclosure with reference to FIG. 6.

To test and validate that the system 100 properly identifies elements, the process 500 then moves to block 516, where an element (or group of elements) in the element repository 22 is selected, for example via a mouse-click in the element repository 22. The process 500 then moves to block 518, where in response to the mouse-click, one of the injected JavaScript code segments is executed by the web browser 14 to visually mark the element in the web page 16 that corresponds to the unique identifier of the element selected in the element repository 22.

The process 500 then moves to block 520, where one or more rules for testing the layout of the elements of the web page 16 are created by the rules module 60 in response to mouse-click and computer keyboard commands in the rules editor 30 of the rules 26 section of the UI 20. As discussed above, the rules may be created based on the properties of a single element (i.e., for testing an individual element) or can define visual relationships between multiple elements of the web page 16. The process 500 then moves to block 522, where one or more of the created rules are executed. The rules may be executed by the rules module 60 in response to mouse-click and/or computer keyboard commands in the rules actions 28 of the rules 26 section of the UI 20, and/or may be executed by the external rule execution engine 80.

The process 500 then moves to block 524, where the results of the rule execution in block 522 are visually displayed. The visual display may be in the results 34 area of the UI 20, separately as a report in the live web page 16, or both in the results are 34 and as a report in the live web page 16.

Note that from block 518, the process 500 may alternatively or additionally move to block 526, where multiple elements are grouped together to create an element group (i.e., group of elements). The group and the properties of the group, are displayed in the groups 35 section of the UI 20. From block 526, the process 500 may then move to block 528, where one or more rules for a group are created. The procedure for creating a group rule is generally similar to the procedure for creating a rule for an individual element or set of elements, as described in block 520, and should be understood by analogy thereto.

Attention is now directed to FIG. 6 which shows a flow diagram detailing a computer-implemented process 600 in accordance with embodiments of the disclosed subject matter. This computer-implemented process includes an algorithm for generating the unique identifier of an element, as generally referred to in block 514 of FIG. 5. The process and sub-processes of FIG. 6 are computerized processes performed by the system 100 including, for example, the CPU 102 and associated components, such as the UI 20, the identification module 50, the rules module 60, and the web browser 14. The aforementioned processes and sub-processes are for example, performed automatically, but can be, for example, performed manually, and are performed, for example, in real-time.

The process 600 begins at block 602, where the system 100 analyzes the extracted element properties of the element to be uniquely identified to check if the element has an id attribute. If such an id attribute exists, the process 600 moves to block 604, where the id attribute is used to uniquely identify the element and the process 600 ends. If such an id attribute does not exist, the process 600 moves to block 606, where the system 100 analyzes the extracted element properties to cheek all attributes of the element in order to determine if one of the attributes is unique in the web page 16. If such a unique attribute is found, the process 600 moves to block 608, where the xpath of the unique attribute (e.g., //*[@name=‘btnK’]) is used to uniquely identify the element and the process 600 ends. If no such unique attribute is found, the process 600 moves to block 610, where the system 100 analyzes the extracted element properties to check whether the node text context of the element is unique in the web page 16. If the node text context is unique, the process 600 moves to block 612, where the xpath of the node text (e.g., //*[text( )=‘OK’]) is used to uniquely identify the element and the process 600 ends. If the node text context is not unique, the process 600 moves to blocks 614-624, where the system 100 recursively checks the unique identification criteria similar to blocks 602, 606, 610 for the parents of the element to be identified until reaching the document root.

Specifically, in block 614, the system 100 retrieves the parent of the element to be uniquely identified. The process 600 then moves to block 616, where the system 100 checks if the parent is the document root. If the document root is reached, the process 600 moves to block 618, where a naïve xpath using the node name and the index of the document root is used to uniquely identify the element. If the document root has not been reached, the process moves from block 616 to block 620, where the system 100 analyzes the properties of the parent element to check if the parent element has an id attribute (similar to the functionality performed in block 602). If such an id attribute exists, the process 600 moves from block 620 to block 618, where the naïve xpath using the id attribute of the parent is used to uniquely identify the element. If the id attribute of the parent does not exist, the process 600 moves from block 620 to block 622, where the system 100 analyzes the properties of the parent to check all attributes of the parent in order to determine if one of the attributes is unique in the web page 16 (similar to the functionality performed in block 606). If such a unique attribute for the parent is found, the process 600 moves from block 622 to block 618, where the naïve xpath using the unique attribute of the parent is used to uniquely identify the element. If no such unique attribute for the parent is found, the process 600 moves from block 622 to block 624, where the system 100 analyzes the properties of the parent to check whether the node text context of the parent is unique in the web page 16 (similar to the functionality performed in block 610). If the node text context is unique, the process 600 moves from block 624 to block 618, where the naïve xpath using the node text of the parent is used to uniquely identify the element. If the node text context of the parent is not unique in the web page, the process 600 moves from block 624 back to block 614 to retrieve the next parent.

Although the embodiments described thus far have pertained to the execution of a graphical user interface (e.g., the UI 20) for testing the visual layout of elements on a web page (e.g., the web page 16) displayed on a web browser (e.g., the web browser 16) in which the user interface and web browser are executed on the same computer (e.g., the computer 10), other embodiments are possible, in which multiple web browsers may be hosted on external servers, remote from the computer on which the user interface is executed. Such embodiments allow for the testing, in parallel, of a web page displayed on different web browser types (including web browsers for both mobile and desktop applications) executed on computers running various operating systems.

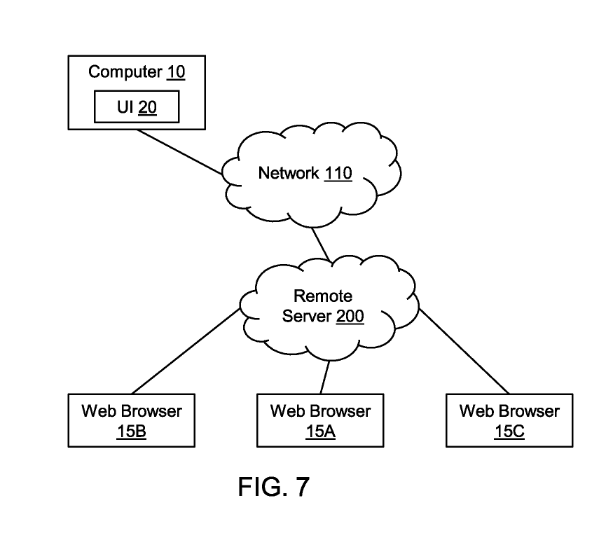

Attention is now directed to FIG. 7 an example environment in which such an embodiment of the present disclosure may be performed over a network, namely the network 110. The computer 10, which includes the UI 20, is connected to a remote server 200, which may be implemented as a datacenter or cloud server, over the network 110. Multiple web browsers, illustrated in the non-limiting example environment of FIG. 7 as three web browser 15a, 15b, 15c, are hosted by the remote server 200. Each of the web browsers 15a-c may be executed on a different respective computer which may run different operating systems. The web browser 15a-c are generally similar to the web browser 14 in terms of functionality and possible browser type and should be understood by analogy thereto. For example, the web browser 15a may be Microsoft® Internet Explorer®, the web browser 15b may be Mozilla Firefox®, and the web browser 15c may be Google Chrome®. Each of the web browsers 15a-c displays the same web page, and the UI 20 is used to test the visual layout of the same web page on each of the different web browsers 15a-c.

As is known in the art, since many, if not most of the web pages displayed by web browsers include stateful information (e.g., user login information, credentials, etc.), HTTP cookies are enabled to store stateful information in the form of data items, sent by the website and stored by the web browser. In the embodiment illustrated in FIG. 7, the UI 20 communicates, for example via tunneling, with the active web page for which the visual layout is tested, in order to retrieve all of the HTTP cookies from the web page. The HTTP cookies are transmitted by the UI 20 to each of the browsers 15a-c and are set in order to provide the web page stateful information to each of the web browsers 15a-c. Thereafter, when one of the remote web browsers 15a-c navigates to the web page for Which the visual layout is being tested, the set HTTP cookies are used by the web browsers 15a-c, thereby bypassing any application state (e.g., login screen) and enabling direct navigation to the target web page under test.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for testing visual aspects of a web page displayed on a web browser executed on a computing device, comprising:
injecting code that includes a plurality of code segments, for execution by the web browser;
selecting a visually marked element on the web page via an input device connected to the computing device;
executing, by the web browser, at least one of the injected code segments to identify the visually marked element as an identified element in response to the selecting; and
extracting properties of the identified element from the web browser.

2. The method of claim 1, further comprising:
generating a unique identifier for the identified element.

3. The method of claim 2, wherein the generating the unique identifier includes checking at least one attribute of the identified element.

4. The method of claim 1, further comprising:
adding the identified element to an element repository.

5. The method of claim 4, wherein the adding includes capturing a screenshot of the identified element.

6. The method of claim 4, further comprising:
selecting, via the input device, the identified element in the element repository; and
visually marking an element in the web page on the browser corresponding to the identified element in the element repository.

7. The method of claim 6, wherein the visually marking the element in the web page includes executing, by the web browser, at least one of the injected code segments.

8. The method of claim 1, further comprising:
creating at least one rule based on at least one extracted property of the identified element.

9. The method of claim 8, wherein the at least one rule includes at least one of: alignment of the identified element, size of the identified element, dimension of the identified element, order of the identified element relative to at least one other element of the web page, and separation of the identified element from at least one other element of the web page.

10. The method of claim 8, further comprising:
executing the at least one rule against the web page on the web browser.

11. The method of claim 1, wherein the web browser is hosted on the computing device.

12. The method of claim 1, wherein the web browser is hosted on a remote computing device having remote access to the computing device.

13. The method of claim 1, further comprising:
grouping the identified element together with at least one other identified element to create a group of elements; and
creating a set of rules for the group of elements, the set of rules defining a visual relationship between the elements in the group of elements.

14. The method of claim 1, wherein the element of the web page includes a document object model (DOM) element.

15. The method of claim 1, wherein the element of the web page includes a hypertext markup language (HTML) element.

16. The method of claim 1, wherein the injected code includes at least one JavaScript code segment.

17. A system for testing visual aspects of a web page displayed on a web browser executed on a computing device, comprising:
a code injection module that injects code, including a plurality of code segments, for execution by the web browser; and
a user interface executing an identification module configured to:
select a visually marked element on the web page via an input device connected to the computing device,
execute, via the web browser, at least one of the injected code segments to identify the visually marked element as an identified element in response to the selecting, and
extract properties of the identified element from the web browser.

18. The system of claim 17, wherein the user interface includes an element repository for storing and listing the identified element.

19. The system of claim 18, wherein the identification module is further configured to: visually mark an element in the web page on the browser corresponding to the identified element in the element repository in response to selection, via the input device, of the identified element in the element repository.

20. The system of claim 17, wherein the user interface includes an element identification attributes area for interactively displaying a generated unique identifier for the identified element.

21. The system of claim 17, wherein the user interface further executes a rules module configured to:
create at least one rule based on at least one extracted property of the identified element.

22. The system of claim 21, wherein the rules module is further configured to execute the at least one rule against the web page on the web browser.

23. The system of claim 21, wherein the user interface includes a script output that generates a rules script, executable on a rules engine, according to the at least one rule created by the rules module.

24. A method for testing visual aspects of a web page displayed on a web browser executed on a computing device, comprising:
injecting code that includes a plurality of code segments, for execution by the web browser;
selecting an area on the web page via the input device;
executing, by the web browser, at least one of the injected code segments to identify an element of the web page located at the selected area;
extracting properties of the identified element; and
generating a unique identifier for the identified element based on the extracted properties.
